(19) United States
(12) Patent Application Publication
(10) Pub. No.: US 2014/0365928 A1
(43) Pub. Date: Dec. 11, 2014

(54) VEHICLE'S INTERACTIVE SYSTEM

(71) Applicants: Markus Andreas Boelter, Changshu (CN); Zi Yun, Changshu (CN); Yilin Liu, Changshu (CN); Linying Kuo, Changshu (CN); Leizhong Zhang, Changshu (CN)

(72) Inventors: Markus Andreas Boelter, Changshu (CN); Zi Yun, Changshu (CN); Yilin Liu, Changshu (CN); Linying Kuo, Changshu (CN); Leizhong Zhang, Changshu (CN)

(21) Appl. No.: 14/241,889

(22) PCT Filed: Aug. 31, 2011
(86) PCT No.: PCT/CN2011/079215

§ 371 Date: Jun. 6, 2014

(51) Int. Cl. G06F 3/01; G06F 3/16; G06F 3/0488; G06F 3/0481; G06F 3/0484

(52) U.S. Cl. CPC G06F 3/017; G06F 3/0481; G06F 3/04847; G06F 3/0488; G06F 3/167
USPC 715/765

(57) ABSTRACT

The inventive concepts relate to a method executable on an interactive system of a vehicle with a touch-sensitive display, the touch-sensitive display including a screen configuration divided into a main area and a plurality of short-cut areas. Each short-cut area may be associated with a corresponding one of a plurality of applications and a pre-selected function of each application. The method may include displaying a representation of each of the plurality of applications in a corresponding one of the short-cut areas, displaying information on one of the plurality of applications in the main area, wherein at least two applications are running, and executing a pre-selected function of an application when a first type of finger gesture of a user is detected regardless of whether the first type of finger gesture is performed in the main area or in a short-cut area.

### FIELD

Embodiments of the present inventive concepts relate to a vehicle's interactive system, and more particularly, to a vehicle's interactive system that directly accesses and controls the content of the applications.

### BACKGROUND

Vehicles are nowadays equipped with a large number of applications that are controllable by the user. For example, passenger cars are often provided with applications such as, e.g., radio, MP3 player, TV, navigation system, telephone, etc. Each of these applications, in turn, has a large number of individual functions like, e.g., browsing up and down through radio stations, increasing and lowering an audio volume, etc., that can be controlled by the driver. In order to facilitate control, a single control unit may be present in the vehicle by which functions of different applications may be controlled. For example, the control of a radio and the setting of the car's air conditioning may be controlled by the same control device.

Such control devices may use different types of actuators such as hard keys, buttons, joysticks, etc. for a user input. Control units relying on such actuators often suffer from the drawback that the actuators are associated with different functions and operation is thus complicated and needs full attention by the user. The user, however, is usually driving the car and may not be able to focus on operation of the control device.

To simplify operation, in German patent application DE 10 2006 018 672 A1, a multifunctional control is disclosed comprising buttons for operation of functional groups. The buttons are arranged at left and right sides of a display unit. Further, the device comprises a touch screen with control elements for calling a pop-up representation of functions.

However, navigating to the different functions via pop-up menus is still quite complicated and distracting for the driver. Moreover, operation by both buttons and touch screen requires handling different operational elements to call a desired function. In addition, the navigation through several subsequent menus is time consuming Further, if a menu item is inadvertently selected by the user, the user needs to find his or her way back through a hierarchical structure of the menu.

### SUMMARY

Embodiments of the present inventive concepts seek to provide a way to actuate vehicle functions that is intuitive, quick, easy, and minimizes distraction for the driver.

Methods, apparatuses, computer-readable medium, and interactive systems in accordance with various embodiments of the inventive concept are provided and disclosed herein. In particular, a method that is executable on an interactive system of a vehicle with a touch-sensitive display is disclosed. The touch-sensitive display may have a screen configuration divided into a main area and a plurality of short-cut areas. Each short-cut area may be associated with each of a plurality of applications, and a pre-selected function of each to application. In some embodiments, the method may comprise: (a) displaying a representation of each of the plurality of applications in each short-cut area, (b) displaying information on one of the plurality of applications in the main area, wherein at least two applications are running, and (c) executing a pre-selected function of an application when a first type of finger gesture of a user is detected regardless of whether the first type of finger gesture is performed in the main area or in a short-cut area.

The method allows the user to call a pre-selected function by performing a finger gesture on the touch-sensitive display independent from display of an application in the main area. This allows the user to quickly access the function in any situation. This may be implemented by associating a pre-selected function with a particular first type of finger gesture as per step (c). A respective function is then executed if the first type of finger gesture is detected, independently from the first type of finger gesture being detected in the main area or in a particular short-cut area. Additionally or alternatively, a pre-selected function may be executed when a second type of finger gesture is detected in a short-cut area and/or in the main area. The second type of finger gesture may, e.g., comprise a static contact of one or more fingers with the touch-sensitive display. The representation may, in particular, comprise a tag and/or a symbol.

In some embodiments, the applications include a first application, a second application, a third application, and a fourth application. This enables control of four applications via the same touch-sensitive display. The pre-selected functions may, in particular, be associated with different applications.

According to some embodiments, the short-cut areas are located at edges of the touch-sensitive display, preferably at different edges of the touch-sensitive display. When driving a car, this facilitates finding the correct area of the display in which the gesture should be performed to call a particular function because the user's hand can feel the edge of the screen without looking at the screen.

In some embodiments, the main area extends over an entire area of the touch-sensitive display not covered by the short-cut areas. This allows for an economical use of the entire display area for displaying applications and for detecting finger gestures.

According to some embodiments, the main area displays different types of functions of a first application to enable a change of the function by the first type of finger gesture and/or displays a current status of a function within the first application to enable adjustment of the status by the first type of finger gesture while a second short-cut area displays a function of a to second application or displays a status of a function within the second application.

The main area and a short-cut area can be associated with different applications. This allows the monitoring and control of different applications simultaneously via a single touch-sensitive display.

According to some embodiments, the status of the function within the second application can be displayed in the main area concurrently with the first application while the type of the second application is displayed in the short-cut area. This enables the user to quickly capture a status of a function of the second application in the main area, while the first application is still running in the main area. The main area may thus be used to display important information of two different applications simultaneously.

In some embodiments, the first type of finger gesture is a point contact with the touch-sensitive display by one finger or a one-finger movement along a line on the touch-sensitive display. It is generally easier for the user to perform a one-finger gesture than a multi-finger gesture which might still otherwise be used to control different functions controllable via the touch-sensitive display.

According to some embodiments, the method further comprises replacing a first application currently displayed in the main area by a second application displayed at a short-cut area once a third type of finger gesture is detected, where the third type of finger gesture includes a two-finger contact along one or more lines toward the second short-cut area. This enables the user to select the application opened in the main area as he wishes. In particular, the user may decide to switch the display in the main area to a different application whenever he or she desires.

In some embodiments, a first, second, and/or third type of finger gesture may be selected from a list of finger gestures based on user input. In some embodiments, said first, second, and/or third type of finger gesture may comprise a point-like contact or a sweeping contact. Even while driving and in a vibrating passenger cabin, the user is usually still able to perform a point-like or a sweeping contact. A point-like contact may comprise contacting the display at a static contact position. A sweeping contact may comprise contacting the display at a contact position and moving the contact position along a line on the display. The sweeping contact may comprise a substantially straight or a curved line of contact. In particular, the sweeping contact may comprise a circular line of contact. Sweeps performed in opposite directions, e.g., from left to right instead of right to left or clockwise instead of counter-clockwise, may, in some embodiments, constitute different types of gestures.

According to some embodiments, step (c) further comprises, when the first type of finger gesture is detected, retaining said screen configuration, and/or further comprises, when the second type of finger gesture is detected, retaining said screen configuration. The configuration of the main area and the short-cut areas is hence retained when the pre-selected function is executed. Hence, even if the user is monitoring information in the main area, he or she may still actuate a pre-selected function by a simple gesture in the associated short-cut area without being required to scale down the display in the main area.

In some embodiments, step (c) further comprises, when the first type of finger gesture is detected, retaining display of said information in the main area, and/or further comprises, when the second type of finger gesture is detected, retaining display of said information in the main area. Thus, the current display of an application in the main area is maintained while the pre-selected function is executed. After actuating that function the user is thus not required to navigate back to the application that was running in the main area.

According to some embodiments, said step (b) of displaying information on one of the plurality of applications in the main area comprises showing, in an object area of the main area, an object associated with a function of said application. The method may further comprise (d) executing said function when the second type of finger gesture of a user is detected in said object area associated with said function.

This allows control of functions of an application currently running in the main area. Hence, a variety of functions of the application may be displayed and actuated via the main area. According to some embodiments, at least one of the applications is a navigation application. The pre-selected function may comprise transmitting a voice notification of directions towards a predetermined destination, a voice notification of a distance to a predetermined destination and/or stopping of navigational support.

According to some embodiments, at least one of the applications is an entertainment application. The pre-selected function may comprise browsing upward or downward through radio station, skipping forward or backward on a CD player or an MP3 player, raising or lowering an audio volume, and/or changing an audio source.

In some embodiments, at least one of the applications is a car setting application. The pre-selected function may comprise raising or lowering a desired passenger cabin temperature, turning on or off a seat heating, raising or lowering a speed of ventilation means, raising or lowering side windows, and/or turning on or off a light source in the passenger cabin.

According to some embodiments, at least one of the applications is a communication application. The pre-selected function may comprise answering an incoming call, starting a telephone call, and/or raising or lowering a volume for a telephone call and/or a call notification.

In some embodiments, each of the one or more short-cut areas is associated with a different application. Alternatively, two or more short-cut areas are associated with a same application.

In some embodiments, each application may be associated with a different execution unit. Each execution unit may be adapted to execute functions of the associated application. The execution units may comprise, e.g., an entertainment unit, a communication unit, a navigation unit, and/or a car setting adjustment unit. The entertainment unit may further comprise a radio, a CD player, and/or a MP3 player. The car setting adjustment unit may, e.g. comprise a climate control unit.

In some embodiments, said executing comprises transmitting, via a communication connection, in particular a bus connector of the interactive system, a trigger signal to an execution unit associated with the respective application. In this embodiment, the execution units may be external to the interactive system. The system may thus be replaced without having to replace the execution units as well. Further, communication via a vehicle bus is preferred for better compatibility with a variety of execution units. Alternatively, one or more execution units may be integral to the interactive system.

According to some embodiments, at least one, preferably each of the plurality of short-cut areas has a largest dimension of at least about 40%, in particular at least about 60% and, preferably, at least 80% of a smallest dimension of the touch-sensitive display.

In some embodiments, the one or more short-cut areas have a smallest dimension of between 2 mm and 40 mm, in particular, between 3 mm and 30 mm and, preferably, between 4 mm and 20 mm With these sizes, the risk of missing the short-cut areas while driving the vehicle is minimized At least one and preferably all of the one or more short-cut areas may be rectangular. This allows the user to easily distinguish between the short-cut areas and the main area.

According to some embodiments, the method further comprises sending an acoustic notification once a finger gesture is detected. Here, the user is informed about how his gesture was interpreted without having to look at the display. The method may further comprise sending different acoustic notifications based on the detected type of gesture. For example, detecting sweeps in the left or right directions, the control device may produce beeps of different frequency via the acoustic notification unit.

According to some embodiments, the screen configuration has at least two, preferably to four short-cut areas. This enables control of a large number of functions and applications, while efficiently using the space available on a rectangular screen.

In some embodiments, neighboring short-cut areas are spaced apart by between 2 mm and 50 mm, in particular between 3 mm and 40 mm and, preferably, between 4 mm and 30 mm This way, the risk of a gesture inadvertently passing through more than one short-cut area is minimized even if the user's finger is shaking due to vibration of the passenger cabin.

In some embodiments, the main area may be of greater size than any of the short-cut areas. The main area may be of greater size than all of the one or more short-cut areas together. The main area may be located in the center of the display. In some embodiments, the short-cut areas extend along entire edges of the display. This way, all of the edges are used for short-cut calling of pre-selected functions, allowing the user to easily locate the short-cut areas.

In a further aspect, embodiments of the present inventive concepts provides a computer-readable medium containing instructions that when executed by an interactive system for controlling vehicle applications with a touch-sensitive display cause the interactive system to perform the method of the aforementioned kind.

In a still further aspect, embodiments of the present inventive concepts provide an interactive system for controlling vehicle applications comprising a touch-sensitive display having a screen configuration divided into a main area and a plurality of short-cut areas, each short-cut area associated with each of a plurality of applications and a pre-selected function of each application. The interactive system may further be adapted to display a representation of each of the plurality of applications in each short-cut area and to display information on one of the plurality of applications in the main area. At least two applications may be running, wherein the system is further adapted to execute a pre-selected function of an application when a first type of finger gesture of a user is detected regardless of whether the first type of finger gesture is performed in the main area or in a short-cut area.

In particular, embodiments of the present inventive concepts provide an interactive system for controlling vehicle applications with a touch-sensitive display that is adapted to perform a method of the aforementioned kind.

The interactive system may further have means for fixedly installing at least a portion of said system including the touch-sensitive display to said vehicle, in particular, into a dashboard of said vehicle. This yields a steady position of the display relative to the driver, such that he or she can easily locate the desired main and/or short-cut areas. The means for fixedly installing may, e.g., comprise a threading, one or more screw holes, and/or one or more clamps.

In particular, the system may have connection means for connecting to a vehicle bus, in particular, a bus connector. In an embodiment, the touch-sensitive display comprises an LCD, an LED, in particular an OLED, and/or a multi-color display unit. Further, a touch-sensitive panel that enables precise and prompt identification of multi-touch gestures may be used. In one example, the touch-sensitive screen may be a capacitive screen. Such display units are easy to manufacture, reliable, and consume little energy. This is especially advantageous in the context of using the control unit in a vehicle.

In a further aspect, embodiments of the present inventive concepts provide a vehicle, in particular, a passenger car, a truck, a motor boat, a plane, or the like, comprising the interactive system of the aforementioned kind.

### SHORT DESCRIPTION OF DRAWINGS

FIG. 1 shows a schematic block diagram of an interactive system according to embodiments of the present inventive concepts.

FIG. 2 shows a first display content of the display of the system according to embodiments of the inventive concepts.

FIG. 3 shows a second display content of the display of the system according embodiments of to the inventive concepts.

FIG. 4 shows a third display content of the display of the system according to embodiments of the inventive concepts.

The foregoing and other features of the inventive concepts will become more readily apparent from the following detailed description, which proceeds with reference to the accompanying drawings.

### DETAILED DESCRIPTION

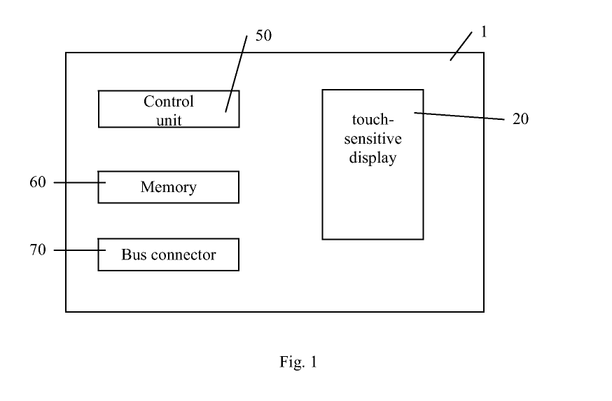

FIG. 1 shows a schematic block diagram of an interactive system 1 according to embodiments of the inventive concepts. The system comprises a touch-sensitive display 20, a control unit 50, a memory 60, and a bus connector 70. The control unit 50 is connected to the memory 60 and is further adapted to execute a program stored in the memory 60. Further, the control unit 50 is connected with the touch-sensitive display 20. The control unit 50 controls the display according to the program stored in the memory 60. Further, the control unit 50 is adapted to receive input from a user via the touch-sensitive display 20. In addition, the control unit 50 is connected to the bus connector 70 to transmit triggering signals to execution units connected to a vehicle bus. The bus connector 70 may be connected to the vehicle bus by any suitable means.

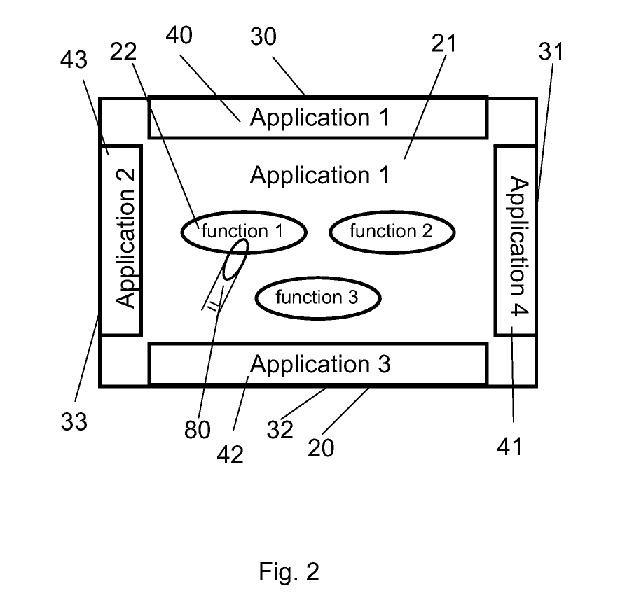

FIGS. 2 to 4 show different display contents of the touch-sensitive display of the interactive system according to embodiments of the inventive concepts. In FIG. 2, the touch sensitive display 20 of the interactive system has a screen configuration that is divided into a main area 21 and four short-cut areas 40, 41, 42, and 43. Each short-cut area 40, 41, 42, and 43 is located at a respective edge 30, 31, 32, and 33 of the touch-sensitive display 20. The short-cut areas 40, 41, 42, and 43 are bar-shaped and extend along the respective edges 30, 31, 32, and 33 of the display 20. Each of the short-cut areas 40, 41, 42, and 43 is associated with a respective one of a plurality of applications and a pre-selected function of the application. Short-cut area 40 located at the upper edge 30 of the touch-sensitive display 20 is associated with “Application 1.” Short-cut area 43 located at the left edge of the display 20 is associated with “Application 2.” Short-cut area 42 located at the lower edge 32 is associated with “Application 3.” Short-cut area 41 located at the right edge 31 is associated with “Application 4.” In each short-cut area 40, 41, 42, and 43, a representation of an application associated with the respective short-cut area is displayed. It will be understood that the screen configuration may include two edges designated for two applications, or three edges designated for three applications, and so forth.

In the main area 21, “Application 1” is displayed. In particular, in the main area, the title “Application 1” is displayed along with three objects labeled “function 1,” “function 2,” and “function 3.” By clicking with one finger 80 on the object labeled “function 1,” the user may actuate “function 1” of “Application 1.” Similarly, the user may actuate each of “function 2 and 3” of “Application 1” by clicking with one finger 80 on the respective object. Further, the user may actuate a pre-selected function by a finger gesture. That is, the user may either actuate a selected function by performing a predetermined first type of finger gesture anywhere on the display, i.e., in the main area 21 or the short-cut areas 41-43. Similarly, he may actuate a predetermined function by clicking with one finger on one of the short-cut areas 40-43 that is associated with the predetermined function. In both cases, the screen configuration shown in FIG. 2 may be retained. Moreover, also the display content in the main area 21 may be retained.

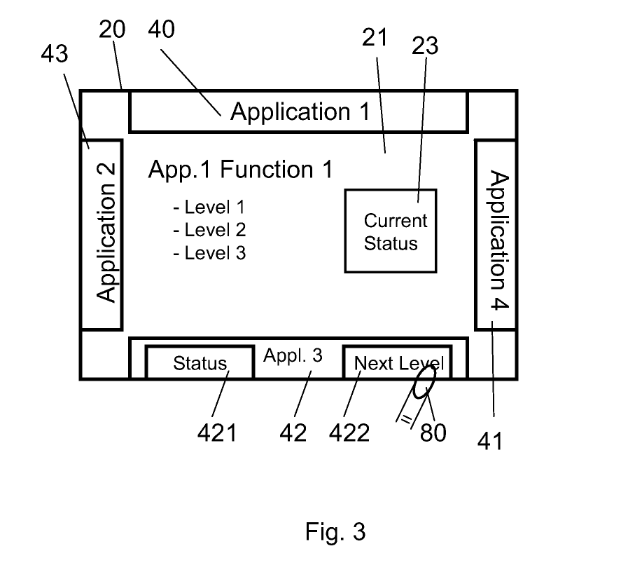

In FIG. 3, a screen configuration of the touch-sensitive display 20 is shown. Similar to the screen configuration shown in FIG. 2, the configuration of FIG. 3 is divided into a main area 21 and four short-cut areas 40, 41, 42, and 43 with each of the short-cut areas being associated with a corresponding one of “Application 1,” “Application 2,” “Application 3,” and “Application 4,” respectively. In the main area 21, in this example, “Application 1” is displayed. In particular, in the main area 21, a menu of functions of “Application 1” is displayed, comprising three different levels of functions, labeled by “Level 1”, “Level 2” and “Level 3”. Moreover, in the main area 21, in this example, a current status 23 of “Application 1” is displayed. Concurrently with the details of “Application 1” being displayed in the main area 21, in the short-cut area 42 associated with “Application 3,” a status field 421 and a button 422 are displayed. In the status field 421 of the short-cut area 42, status information on “Application 3” is displayed. Further, by clicking with one finger 80 on the button 422 of the short-cut area 42, the user may navigate to a next level within a menu of “Application 3.”

With the screen configuration shown in FIG. 3, the user may simultaneously monitor status information of two different applications, i.e., “Application 1” and “Application 3.” Further, the user may also navigate through menus of each of these two applications. This enables a more detailed monitoring and controlling of vehicle applications. The interactive system can execute the pre-selected function if it detects a first type of finger gesture in the main or the short-cut areas. Alternatively, the interactive system can execute the pre-selected function in the main area if it detects a first type of finger gesture in the main area, and can execute the pre-selected function in the short-cut areas if it detects a second type of finger gesture in one of the short-cut areas 40, 41, 42, or 43.

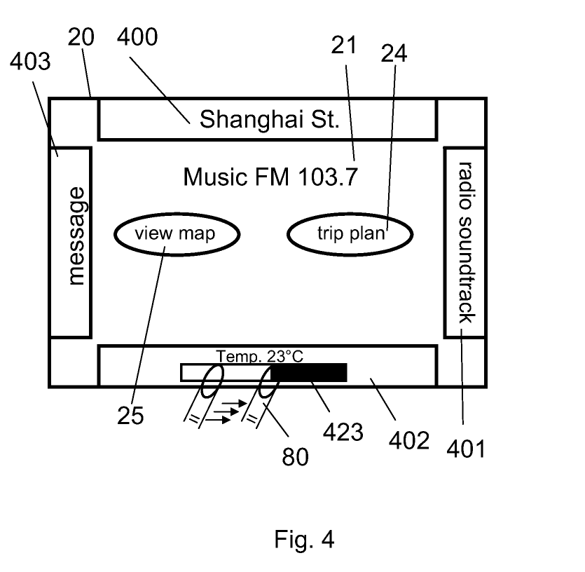

In FIG. 4, a screen configuration of the touch-sensitive display 20 of the interactive system of the inventive concepts is shown. The screen configuration of the touch-sensitive display 20 is divided into a main area 21 and four short-cut areas 400, 401, 402, and 403. Each of the short-cut areas 400, 401, 402, and 403 is located at a respective edge of the rectangular display 20. Short-cut area 400 located at the upper edge of the touch-sensitive display 20 can be associated with a navigation application. In the short-cut area 400, a street along which the vehicle is currently driving can be displayed, e.g., “Shanghai St.” Short-cut area 401 located at the right edge of the touch-sensitive display 20 can be associated with an entertainment application. In short-cut area 401, the name of a radio soundtrack currently playing is displayed. Short-cut area 402 located at the lower edge of the display 20 can be associated with a car setting application. In the short-cut area 402, a temperature bar 423 can be displayed.

The user may adjust a desired temperature by a one-finger 80 movement on the bar 423. By a one-finger movement to the right, the user may increase the desired temperature, while by a one-finger movement to the left, he may decrease the desired temperature. Further, in short-cut area 402, a current temperature of the passenger cabin is shown, e.g., 23° C. Short-cut area 403 located at the left edge of the touch-sensitive display can be associated with a communication application. In short-cut area 403, a previously received message can be displayed.

In the main area 21 of the touch-sensitive display 20, information associated with the entertainment application can be displayed, e.g., the frequency of a currently playing radio station. Moreover, in the main area 21, two objects associated with the navigation application can be displayed: a button 24 labeled “trip plan” and a button 25 labeled “view map.” By clicking with one finger on the button labeled “trip plan,” the user may cause the system to display in the main area 21 information on the current trip plan. Similarly, by clicking on the button labeled “view map,” the user may cause the system to display in the main area 21 map information. Further, by performing a predetermined first type of finger gesture anywhere on the display 20, i.e., in the main area 21 or in the short-cut areas 400, 401, 402, and/or 403, the user may actuate a pre-selected function associated with one of the applications.

It will be understood that the interactive system of the present information may recognize different type of finger gestures that are configured to perform a desired function. For example, the gesture may include a finger-gesture and a multiple finger gesture. The multiple finger gesture may include two-finger touch, three-finger touch, four-finger or five-finger touch on the touch-sensitive screen in a predetermined pattern recognizable by the interactive system. In one example, the predetermined pattern may be a finger touch pattern that is easily performed by a user, such as a static contact, movement of one finger, and/or or multiple fingers alone line(s) or curves.

Further modifications of the described embodiments are possible without leaving the scope of the various embodiments of the present inventive concepts, which is defined by the enclosed claims. For example, the short-cut areas associated with the applications may be displayed at the center of the display, and/or the display may comprise more than four shortcut areas. In some embodiments, the main area does not extend to the edges of the display. In some embodiments, the interactive system is integrated into a control device of the vehicle for controlling vehicle applications.

1. A method executable on an interactive system of a vehicle including a touch-sensitive display, the touch-sensitive display including a screen configuration divided into a main area and a plurality of short-cut areas, each short-cut area associated with a corresponding one of a plurality of applications and a pre-selected function of each application, the method comprising:
displaying a representation of each of the plurality of applications in a corresponding one of the short-cut areas;
displaying information on one of the plurality of applications in the main area;
wherein at least two applications are running; and
executing a pre-selected function of an application when a first type of finger gesture of a user is detected regardless of whether the first type of finger gesture is performed in the main area or in a short-cut area from among the plurality of short-cut areas.

2. The method of claim 1, further comprising executing a pre-selected function of an application when a second type of finger gesture of the user is detected regardless of whether the second type of finger gesture is performed in the main area or in a short-cut area.

3. The method of claim 1, wherein the applications include a first application, a second application, a third application, and a fourth application.

4. The method of claim 1, further comprising locating the short-cut areas at different edges of the touch-sensitive display.

5. The method of claim 1, further comprising extending the main area over an entire area of the touch-sensitive display not covered by the short-cut areas.

6-18. (canceled)

19. The method of claim 1, further comprising displaying, in the main area, different types of functions of a first application to enable a change of the function by the first type of finger gesture while a second short-cut area displays a function of a second application.

20. The method of claim 19, further comprising displaying, in the main area, a current status of a function within the first application to enable adjustment of the status by the first type of finger gesture while a second short-cut area from among the plurality of short-cut areas displays a status of a function within the second application.

21. The method of claim 20, wherein the status of the function within the second application is displayed in the main area concurrently with the first application while the type of the second application is displayed in the short-cut area.

22. The method of claim 20, wherein the first type of finger gesture is a point contact with the touch-sensitive display by one finger or a one-finger movement along a line on the touch-sensitive display.

23. The method of claim 20, further comprising replacing a first application currently displayed in the main area by a second application once a third type of finger gesture is detected, wherein the third type of finger gesture includes a two-finger contact along one or more lines toward the second short-cut area.

24. The method of claim 2, further comprising, when the first type of finger gesture is detected, retaining each of the plurality of applications in the corresponding main area and the short-cut areas.

25. The method of claim 2, further comprising, when the second type of finger gesture is detected, retaining each of the plurality of applications in the corresponding main area and the short-cut areas.

26. The method of claim 2, wherein said displaying information on one of the plurality of applications in the main area comprises showing, in an object area of the main area, an object associated with a function of said application, and wherein the method further comprises:
executing said function when the second type of finger gesture of a user is detected in said object area associated with said function.

27. The method of claim 1, wherein at least one of the short-cut areas has a largest dimension of one of (i) at least about 40%, (ii) at least about 60%, or (iii) at least about 80% of a smallest dimension of the touch-sensitive display.

28. The method of claim 1, further comprising:
sending an acoustic notification once a finger gesture is detected.

29. The method of claim 1, wherein neighboring short-cut areas are spaced apart by one of (i) between 2 mm and 50 mm, (ii) between 3 mm and 40 mm, or (iii) between 4 mm and 30 mm.

30. A computer-readable medium containing instructions that when executed by an interactive system for controlling vehicle applications with a touch-sensitive display cause the interactive system to perform the method of claim 1.

31. An interactive system for controlling vehicle applications, the system comprising:
a touch-sensitive display including a screen configuration divided into a main area and a plurality of short-cut areas, each short-cut area associated with a corresponding one of a plurality of applications and a pre-selected function of each application, the interactive system further being adapted to display a representation of each of the plurality of applications in a corresponding one of the short-cut areas, and to display information on one of the plurality of applications in the main area, wherein at least two applications are running, and
wherein the interactive system is further adapted to execute a pre-selected function of an application when a first type of finger gesture of a user is detected regardless of whether the first type of finger gesture is performed in the main area or in a short-cut area.

32. The system of claim 31, wherein the interactive system is further adapted to execute a pre-selected function of an application when a second type of finger gesture of the user is detected regardless of whether the second type of finger gesture is performed in the main area or in a short-cut area.

33. The system of claim 31, wherein the interactive system is further adapted to display, in the main area, different types of functions of a first application to enable a change of the function by the first type of finger gesture while a second short-cut area displays a function of a second application.
